(19) United States
(12) Patent Application Publication
(10) Pub. No.: US 2017/0005484 A1
(43) Pub. Date: Jan. 5, 2017

(54) POWER STORAGE SYSTEM

(71) Applicant: SANYO ELECTRIC CO., LTD., Daito-shi (JP)

(72) Inventors: Natsuhiko MUKAI, Osaka (JP); Masato FUJIKAWA, Osaka (JP)

(73) Assignee: SANYO ELECTRIC CO., LTD., Daito-shi (JP)

(21) Appl. No.: 15/112,896

(22) PCT Filed: Jan. 27, 2015
(86) PCT No.: PCT/JP2015/000342

§ 371 Date: Jul. 20, 2016

(30) Foreign Application Priority Data
Jan. 31, 2014 (JP) 2014-016564

(51) Int. Cl. H02J 7/00; H01M 10/44

(52) U.S. Cl. CPC H02J 7/007; H01M 10/44; H02J 7/0013

(57) ABSTRACT

An object of the present invention is to provide a power storage system having a high energy density, in which degradation of cycle characteristics is suppressed. The power storage system has a battery pack mounted therein and is characterized by having an energy density of 35 Wh/L or more and continuously performing constant current charge at a low-rate current value of 0.2 It or less from start of charge to completion of charge. The degradation of the cycle characteristics is suppressed even in the power storage system having a high energy density, in which the heat generation density per unit volume is high and the temperature of the battery pack or the batteries in the battery pack is prone to increase.

### TECHNICAL FIELD

The present invention relates to a power storage system.

### BACKGROUND ART

Portable and cordless electronic devices are in increasingly wide spread use in recent years and demands for compact and lightweight secondary batteries having high energy densities are increased as power supplies for driving the electronic devices. In addition to compact consumer applications, deployment of technology for large secondary batteries which are used in power storage applications and electric vehicle applications and for which long-term durability and safety are required has also been accelerated. Non-aqueous electrolyte secondary batteries, particularly, lithium secondary batteries are expected to be used because they have high voltage and high energy densities.

In addition to performances required for electronic devices in related art, features including supports of high capacity, long life, and low temperature environment are further required for the power storage applications.

As a technology for the long life support, a method of performing constant current charge at a charge rate from a medium rate (0.5 It) to a high rate (2 It) is proposed, for example, in terms of improvement of cycle characteristics of the lithium secondary batteries (refer to PTL 1). Here, “It” represents a current value and the current value at which a rated capacity (Ah) of a battery is charged (or discharged) in one hour is “1 It”. Since the use of this method reduces excessive deintercalation of lithium at a positive electrode to suppress fracture of grids, the cycle characteristics are said to be improved.

### CITATION LIST

### Patent Literature

PTL 1: Japanese Published Unexamined Patent Application No. 2006-024392

### SUMMARY OF INVENTION

### Technical Problem

In response to expansion of the power storage markets in recent years, the power storage systems are further required to have high energy densities in order to enable use of various devices for long periods of time and installation of the devices in small spaces. However, it is necessary to take new measures against increase in resistance and heat emission with the increasing energy densities of the power storage systems.

Charging the power storage systems having high energy densities with the charging method described in PTL 1 causes reactive portions in the batteries to be deeply charged and non-reactive portions therein not to react so much to advance the charging, thereby causing variation in the reaction. As a result, there is a problem in that the cycle characteristics are degraded to deteriorate the batteries to an unacceptable level in real use.

In addition, charging the power storage systems having high energy densities with rather high current values increases joule heat that is generated to increase the heat generation densities per unit volume of the power storage systems at accelerated rates. As a result, there is also a problem in that the temperatures of the power storage systems are increased to cause the batteries to deteriorate quickly.

An object of the present invention is to provide a power storage system capable of suppressing degradation of the cycle characteristics.

### Solution to Problem

In order to resolve the above problems, the present invention provides a power storage system having a battery pack mounted therein, which is characterized by having an energy density of 35 Wh/L or more and continuously performing constant current charge at a current value of 0.2 It or less from start of charge to completion of charge. The time when the power storage system start charging corresponds to the start of charge and the time when the power storage system completes the charging at a voltage that is set corresponds to the completion of charge.

### Advantageous Effects of Invention

According to the present invention, it is possible to provide the power storage system capable of suppressing the degradation of the cycle characteristics.

### BRIEF DESCRIPTION OF DRAWINGS

FIG. 1 is a graph illustrating the relationship between the charge rate and the heat release rate of a power storage system according to an embodiment of the present invention and a power storage system in related art.

FIG. 2 schematically illustrates the power storage system according to the embodiment of the present invention.

FIG. 3 is a cross-sectional view of a battery according to the embodiment of the present invention.

### DESCRIPTION OF EMBODIMENTS

The present invention provides a power storage system having a battery pack mounted therein, which is characterized by having an energy density of 35 Wh/L or more and continuously performing constant current charge at a current value of 0.2 It or less from start of charge to completion of charge. With the above configuration, it is possible to suppress degradation of cycle characteristics of the power storage system.

Embodiments of the present invention will herein be described with reference to the attached drawings, taking a lithium secondary battery as an example. Values indicated below are not be limitedly used.

In power storage systems having high energy densities, charging with rather high current values increases joule heat that is generated to increase the heat generation densities per unit volume of the power storage systems at accelerated rates. As a result, there is a problem in that the temperatures of the power storage systems are increased to cause the batteries to deteriorate quickly. Accordingly, the heat generation in the system is suppressed by using the power storage system characterized by having an energy density of 35 Wh/L or more and continuously performing the constant current charge at a current value of 0.2 It or less from start of charge to completion of charge to suppress the deterioration of the battery.

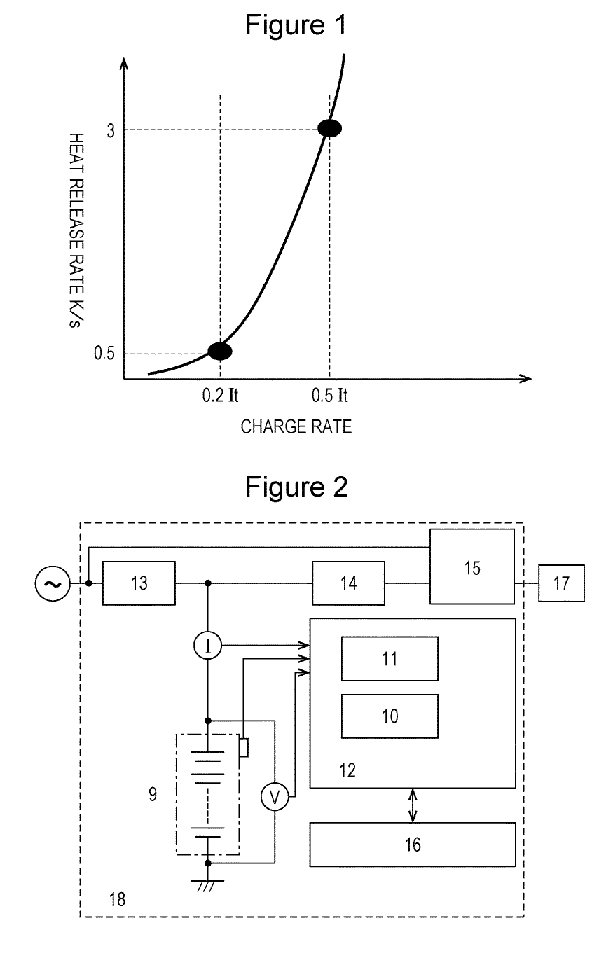

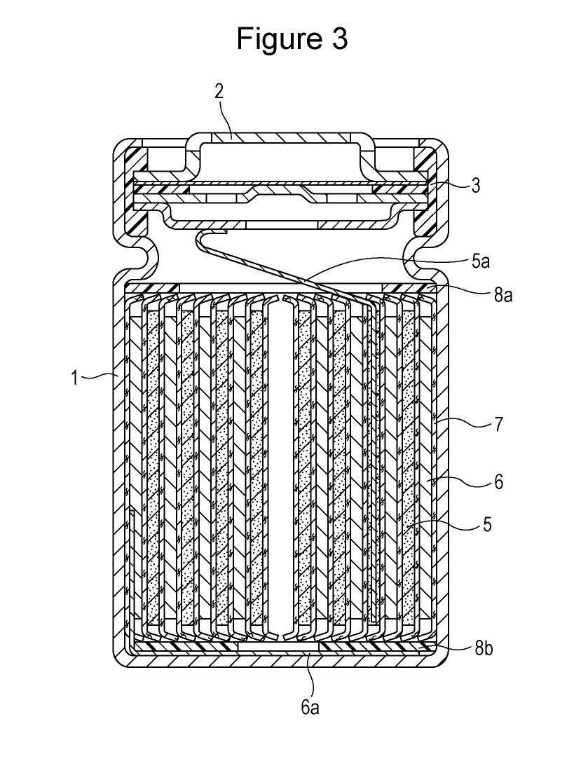

As illustrated in FIG. 1, when the energy density of the power storage system is 35 Wh/L and heat capacity is 23,000 J/K, decreasing the charge current value from 0.5 It to 0.2 It allows the heat release rate of the system to be decreased to ⅙ (0.1 It=11 A in the present embodiment).

When the energy density of the battery pack mounted in the power storage system is 300 Wh/L or more, the proportion of the battery pack in the system is increased to cause the temperature of the power storage system to be prone to increase in response to the heat release from each battery. Accordingly, this setting is preferably exemplified because the effect of suppressing the deterioration of the present invention is made apparent.

When the energy density of each battery in the battery pack mounted in the power storage system is 500 Wh/L or more, the reactance area of polar plates of the battery tends to decrease with the same material system, the resistance is increased to increase the joule heat, the heat generation density per unit volume of the power storage system is increased at an accelerated rate, and the temperature of the power storage system is also increased. Accordingly, this setting is preferably exemplified because the effect of suppressing the deterioration of the present invention is made apparent.

When the heat capacity of the entire power storage system is 30,000 J/K or less, the temperature of the power storage system tends to increase in response to the heat release from each battery. Accordingly, this setting is preferably exemplified because the effect of suppressing the deterioration of the present invention is made apparent.

An embodiment of the present invention will now be described.

The power storage system includes at least one battery pack and a converter electrically connected to the battery pack.

As illustrated in FIG. 2, a battery pack 9 is composed of a battery, a frame holding the battery, and a current collector plate. In the case of the lithium secondary battery, multiple batteries may be connected in series or in parallel in the battery pack.

The power storage system includes an inverter 14, a converter 13, a detection unit 12, and an outer package, in addition to the battery pack 9.

The outer package is made of iron, aluminium, copper, resin, and so on. The principal component of the outer package may be resin. The battery includes a positive electrode active material, a negative electrode active material, and a separator. Lithium compound oxide or the like is used as the positive electrode active material, graphite or the like is used as the negative electrode active material, and polypropylene and polyethylene or the like are used as the separator. When the same material system is used, increasing the capacity of the battery in design increases the weight of the active materials per unit area and decreases the ratio of the separator and current collectors, which do not contribute the reaction. Accordingly, the reaction area in the battery is decreased to increase the resistance.

### EXAMPLES

### Example 1

### (1) Production of Negative Electrode

100 parts by weight of graphite and 1 part by weight of styrene-butadiene rubber were mixed into water as the negative electrode active material and binding agent, respectively, to produce slurry. This slurry was applied on both sides of a negative electrode current collector made of copper and the slurry applied on both sides of the negative electrode current collector was dried. Then, the negative electrode current collector having the dried slurry on both sides was rolled and was cut into a length of 700 mm and a width of 60 mm to produce a negative electrode 6.

(2) Production of Positive Electrode 100 parts by weight of lithium nickel oxide, 1 part by weight of acetylene black, and 3 parts by weight of polyvinylidene fluoride (PVDF) were mixed into N-methylpyrrolidone (NMP) as the positive electrode active material, conductive agent, and biding agent, respectively, to produce positive electrode mixture slurry. This positive electrode mixture slurry was applied on both sides of a positive electrode current collector made of aluminium and the positive electrode mixture slurry applied on both sides of the positive electrode current collector was dried. Then, the positive electrode current collector having the applied and dried positive electrode mixture slurry on both sides was rolled and was cut into a length of 600 mm and a width of 59 mm to produce a positive electrode 5.

### (3) Preparation of Non-Aqueous Electrolyte

LiPF₆ was dissolved into mixed solvent at a concentration of 1.4 mol/m³ and vinylene carbonate was added as additive by 5% to prepare non-aqueous electrolyte. The mixed solvent results from mixture of ethylene carbonate, ethylmethyl carbonate, and dimethyl carbonate so as to have a volume ratio of 1:1:1 as non-aqueous solvent.

### (4) Production of Cylindrical Battery

After a positive electrode lead 5a made of aluminium and a negative electrode lead 6a made of nickel were mounted to the current collectors of the positive electrode 5 and the negative electrode 6, the positive electrode 5 and the negative electrode 6 were wound via a separator 7 to compose a polar plate group.

Next, an upper insulating plate 8a was provided on the top of the polar plate group, a lower insulating plate 8b was provided on the bottom of the polar plate group, the negative electrode lead 6a was welded to a battery case 1, and the positive electrode lead 5a was welded to a sealing plate 2 having a safety valve of an internal pressure driven type to storage the battery in the battery case 1.

The non-aqueous electrolyte was injected into the inside of the battery case 1 using a pressure reduction method and an open end of the battery case 1 was crimped to the sealing plate 2 via a gasket 3 to complete the battery. The battery of 18650 size (diameter: 18 mm, height: 65 mm) was used.

The amount of the active materials was adjusted so that the batteries have three kinds of energy densities: 300 Wh/L, 400 Wh/L, and 500 Wh/L to design the batteries.

The battery packs using these batteries were designed and produced. The ratios of the batteries in the battery packs were adjusted so that the battery packs have three kinds of energy densities: 100 Wh/L, 200 Wh/L, and 300 Wh/L to design the battery packs.

The power storage systems using these battery packs were designed and produced. The ratios of the battery packs in the power storage systems were adjusted so that the power storage systems have three kinds of energy densities: 25 Wh/L, 30 Wh/L, and 35 Wh/L to design the power storage systems.

The systems were designed so as to have three kinds of heat capacities: 50,000 J/K, 40,000 J/K, and 30,000 J/K.

### (5) Evaluation of System

The cycle characteristics were measured using the power storage systems having energy densities of 25 Wh/L, 30 Wh/L, and 35 Wh/L, which were produced using the battery packs having an energy density of 300 Wh/L.

Charge and discharge of the power storage systems were performed using the following three methods.

The constant current charge was performed until the voltage reaches an upper limit voltage of 4. 2 V with the charge current value being set to 0.2 It and constant current discharge was performed with a discharge current value being set to 0.3 It and discharge termination voltage being set to 3.0 V (hereinafter referred to as “0.2 It constant current).

The constant current charge was performed until the voltage reaches an upper limit voltage of 4. 2 V with the charge current value being set to 0.5 It and the constant current discharge was performed with the discharge current value being set to 0.3 It and the discharge termination voltage being set to 3.0 V (hereinafter referred to as “0.5 It constant current).

The constant current charge was performed until the voltage reaches an upper limit voltage of 4. 2 V with the charge current value being set to 0.2 It, constant voltage charge was performed until the current reaches termination current of 50 mA, and the constant current discharge was performed with the discharge current value being set to 0.3 It and the discharge termination voltage being set to 3.0 V (hereinafter referred to as “0.2 It constant current-constant voltage).

The capacity maintenance rate of the battery when 500 cycles elapsed was calculated in the power storage systems charged and discharged using the respective methods with the discharge capacity at the third cycle being set to 100% and the calculated capacity maintenance rate was used as a cycle retention rate. The result is illustrated in Table 1.

TABLE 1

| | | | | 0.2 It |
|---|---|---|---|---|
| Pack | System | | | constant |
| energy | energy | 0.2 It | 0.5 It | current- |
| density | density | constant | constant | constant |
| Wh/L | Wh/L | current | current | voltage |
| 300 | 35 | 96% | 69% | 70% |
| 300 | 30 | 97% | 84% | 85% |
| 300 | 25 | 98% | 85% | 86% |

### Example 2

The power storage systems having an energy density of 35 Wh/L were produced using the battery packs having energy densities of 100 Wh/L, 200 Wh/L, and 300 Wh/L and the cycle characteristics were measured, as in Example 1. The result is illustrated in Table 2.

TABLE 2

| | | | | 0.2 It |
|---|---|---|---|---|
| System | Pack | | | constant |
| energy | energy | 0.2 It | 0.5 It | current- |
| density | density | constant | constant | constant |
| Wh/L | Wh/L | current | current | voltage |
| 35 | 300 | 96% | 70% | 71% |
| 35 | 200 | 97% | 85% | 86% |
| 35 | 100 | 98% | 86% | 87% |

### Example 3

The battery packs having an energy density of 400 Wh/L were produced using the batteries having energy densities of 300 Wh/L, 400 Wh/L, and 500 Wh/L, the power storage system was produced using the battery packs, and the cycle characteristics were measured, as in Example 1. The result is illustrated in Table 3.

TABLE 3

| | | | | 0.2 It |
|---|---|---|---|---|
| Pack | Battery | | | constant |
| energy | energy | 0.2 It | 0.5 It | current- |
| density | density | constant | constant | constant |
| Wh/L | Wh/L | current | current | voltage |
| 300 | 500 | 96% | 71% | 72% |
| 300 | 400 | 97% | 85% | 87% |
| 300 | 300 | 98% | 86% | 87% |

### Example 4

The three kinds of the power storage systems having heat capacities of 30,000 J/K, 40,000 J/K, and 50,000 J/K were produced using the battery packs having an energy density of 300 Wh/L and the cycle characteristics were measured, as in Example 1. The result is illustrated in Table 4.

TABLE 4

| | | | | 0.2 It |
|---|---|---|---|---|
| Pack | System | | | constant |
| energy | heat | 0.2 It | 0.5 It | current- |
| density | capacity | constant | constant | constant |
| Wh/L | J/K | current | current | voltage |
| 300 | 30,000 | 96% | 72% | 73% |
| 300 | 40,000 | 97% | 86% | 87% |
| 300 | 50,000 | 98% | 87% | 88% |

Table 1 indicates that the cycle retention rates were high in all the power storage systems in the 0.2 It constant current charge while the cycle retention rate was decreased in the power storage system having an energy density of 35 Wh/L in the 0.5 It constant current charge and the 0.2 It constant current-constant voltage charge. This may be because the heat generation density per unit volume is high in the power storage system having an energy density of 35 Wh/L and the temperature of the battery pack or the batteries in the battery pack is increased to deteriorate the battery pack or the batteries.

Table 2 indicates that the cycle retention rates were high in all the power storage systems in the 0.2 It constant current charge while the cycle retention rate was decreased in the power storage system using the battery pack having an energy density of 300 Wh/L in the 0.5 It constant current charge and the 0.2 It constant current-constant voltage charge. This may be because the heat generation density per unit volume is high in the power storage system using the battery pack having an energy density of 300 Wh/L and the temperature of the battery pack or the batteries in the battery pack is increased to deteriorate the battery pack or the batteries.

Table 3 indicates that the cycle retention rates were high in all the power storage systems in the 0.2 It constant current charge while the cycle retention rate was decreased in the power storage system using the battery having an energy density of 500 Wh/L in the 0.5 It constant current charge and the 0.2 It constant current-constant voltage charge. This may be because the heat generation density per unit volume is high in the system using the battery having an energy density of 500 Wh/L and the temperature of the battery pack or the batteries in the battery pack is increased to deteriorate the battery pack or the batteries.

Table 4 indicates that the cycle retention rates were high in all the power storage systems in the 0.2 It constant current charge while the cycle retention rate was decreased in the power storage system having a heat capacity of 30,000 J/K in the 0.5 It constant current charge and the 0.2 It constant current-constant voltage charge. This may be because the heat generation density per unit volume is high in the power storage system having a heat capacity of 30,000 J/K and the temperature of the battery pack or the batteries in the battery pack is increased to deteriorate the battery pack or the batteries.

The reduction in the cycle retention rate was small in the 0.2 It constant current charge, compared with those in the 0.5 It constant current charge and the 0.2 It constant current-constant voltage charge, in the power storage systems in Examples 1 to 4. This indicates that the constant current charge at a low current value (0.2 It or less) as in the present invention suppresses the degradation of the cycle characteristics to achieve the long life of the power storage system even in a situation in which the heat generation density of the power storage system is high depending on the difference in the configuration condition of the power storage system.

Although the cylindrical battery is used in the above examples, the same advantages are achieved using a battery of, for example, a rectangular shape.

### INDUSTRIAL APPLICABILITY

The power storage system using the charging method of the present invention is excellent in the cycle characteristics and is useful as a power source for household use and a large storage power source for industrial use, such as for base stations and for factories.

### REFERENCE SIGNS LIST

1battery case

2sealing plate

3 gasket

5 positive electrode

5a positive electrode lead

6 negative electrode

6a negative electrode lead

7 separator

8a upper insulating plate

8b lower insulating plate

9 battery pack

10 charge and discharge control unit

11 state detection unit

12 detection unit

13 converter

14 inverter

15 power supply switching unit

16 storage unit

17 load

18 power storage system

1. A power storage system having a battery pack mounted therein,
wherein the power storage system has an energy density of 35 Wh/L or more, and
wherein the power storage system continuously performs constant current charge at a current value of 0.2 It or less from start of charge to completion of charge.

2. The power storage system according to claim 1,
wherein the battery pack has an energy density of 300 Wh/L or more.

3. The power storage system according to claim 1,
wherein a battery housed in the battery pack has an energy density of 500 Wh/L or more.

4. The power storage system according to claim 1.
wherein the power storage system has a heat capacity of 30,000 J/K or less.
